(19) United States
(12) Patent Application Publication
(10) Pub. No.: US 2023/0324264 A1
(43) Pub. Date: Oct. 12, 2023

(54) AIR SAMPLING SYSTEM AND METHOD

(71) Applicant: AIRDAR INC., Edmonton (CA)

(72) Inventors: Dennis PRINCE, Edmonton (CA); Brendan MATKIN, Edmonton (CA); Terry BUTLER, Edmonton (CA)

(21) Appl. No.: 18/043,187

(22) PCT Filed: Aug. 27, 2021
(86) PCT No.: PCT/CA2021/051195

§ 371 Date: Feb. 27, 2023

Related U.S. Application Data
(60) Provisional application No. 63/071,306, filed on Aug. 27, 2020.

(51) Int. Cl. G01N 1/26; G01N 1/22; G01N 1/24

(52) U.S. Cl. CPC G01N 1/26; G01N 1/2273; G01N 1/24; G01N 2001/021

(57) ABSTRACT

An air sampling system and method are provided to collect air samples from a plurality of air sample inlets. Before or after transmitting an air sample originating from one of the sample inlets, a signal gas is transmitted via the sample line in accordance with one of a plurality of predefined burp patterns, each of which uniquely corresponds to a different one of the sample inlets. The sample line is monitored for the signal gas in accordance with the predefined burp patterns. Based on detection of the signal gas in the sample line in accordance with one of the predefined burp patterns, a related action is taken. The related action can be identifying the sample inlet from which the air sample originated, or further transmitting the air sample via the sample line.

### CROSS REFERENCE TO RELATED APPLICATION

This application claims priority to U.S. patent application No. 63/071,306, filed on Aug. 27, 2020, the entire contents of which are incorporated herein, where permitted.

### TECHNICAL FIELD

The present invention relates to gas monitoring in general, and to apparatuses and methods for determining sources of emissions in particular.

### BACKGROUND

There is a need to measure gas emissions across very large geographical areas, such as to identify emission sources or leaks from facilities or assets such as pipelines, oil wells, compressor stations, and sewer systems. For example, methane in the atmosphere can cause a greenhouse effect which contributes to climate change. It is important that these emission sources are accurately identified to effectively direct mitigation efforts for reducing greenhouse gas emissions and other emissions of concern.

There is a long list of potential sources of methane that are not well understood (oil and gas activities, farming and livestock, city sewers, natural sources like methane hydrates (i.e., frozen methane)). Society is moving to address the concern with Greenhouse Gas (GHG) emissions with several large players (Shell, BP, Total) committing to net zero emissions by 2050. However, this process will be expensive. Due to uncertainty about the exact nature of these emissions, cost is a concern; organizations might allocate resources to the wrong problem and not solve the issue, they might think their approach is working when it is not, and/or some will say they have achieved net zero emissions when they have not.

For example, some approaches to net zero emissions involve carbon sequestration and storage. A system is needed to ensure the CO₂ is not leaking or is not accidentally released by other activities, such as fracking. The fracking process itself may be releasing methane into the atmosphere through inadvertent fissures in old geological formations. Among other concerns, issues that need to be addressed include: determining the amount of methane that is coming from fracking, processing and distribution of natural gas; determining the amount of methane that is coming from city sewer systems; whether ground-sequestered CO₂ is actually contained below ground; whether such CO₂ is leaking from unsuspected locations a great distance from the points of injection. The answer to these questions is uncertain at this time and would require the continuous measurement of emissions over large areas to remove or reduce such uncertainty. In fact, society's ability to achieve their climate change goals may depend on the ability to locate and measure leaks and emission sources.

Traditional leak detection activities involve intercepting the plume of an emission source near the point of release (where concentrations are high) with an instrument that has a relatively high detection limit; e.g. handheld sniffers or IR cameras. This requires workers to move these instruments into position to record readings, which can be time consuming, hazardous, and susceptible to operator bias or error. Traditional fence line monitoring activities involve collecting air samples far away from sources, on the fence line (where concentrations are relatively low). The samples are collected using passive sampling media or vacuum canisters and sent to a laboratory for analysis using sensitive instruments like a gas chromatograph (GC).

Leak detection and fence line monitoring activities have evolved over time to address concerns about fugitive emissions. These activities are expensive, and their frequency is dictated by regulations. There is a need to increase the efficiency and effectiveness of these activities.

U.S. Pat. Nos. 7,523,638, 7,743,643, 7,934,412, 8,510,059, and 8,949,037, and Canadian patent no. 2,476,902 disclose systems and methods that can identify plume signatures in ambient data with sensors that are either stationary or in motion, but the ability to isolate these signatures can be impeded by multiple plume signatures present of similar size or not enough data to clearly define the plume signature or a combination of these interferences. Extending the geographical range of sensors, and increasing the number of sensors may help address these problems.

U.S. Pat. No. 8,949,037 describes an air sample monitoring system having an equipment package servicing a group of sample inlets. Air samples are drawn from each sample inlet down sample lines to the equipment package. The equipment package includes the following components: a valve manifold configured to couple a selected air sample flow from one of the sample lines to a sample analysis stream; a vacuum source configured to draw air samples via the air sample inlets and thereby to convey the air samples to the equipment package; a sample analyzer configured to receive an air sample from the sample analysis stream and to perform a measurement on the air sample; and a controller configured to actuate valves of the valve manifold, activate the analyzer, and receive and log data including an indication of which air sample stream is being analyzed in the sample analysis stream, among other information.

In this prior art air sample monitoring system, the indication of which air sample stream is being analyzed is based on positions of valves in the valve manifold that are pre-assigned to sample inlet locations and their associated sample line. There may be circumstances where it would be desirable to confirm that the valve position has actually changed, and that the air sample stream under analysis has not been contaminated (e.g., due to leakage in the system). Further, each sample inlet is connected to the equipment package with its own sample line that extends the entire distance from the sample inlet to the equipment package. Therefore, an increase in the number of sample inlets results in a non-trivial increase to the total number and the total length of the sample lines.

The need to extend the range of air monitoring is particularly acute where monitoring is being performed continuously. One option is to use independent sensors (i.e., that are not connected by tubing), but such sensors tend to have high detection limits, and thus likely cannot compete on range. Other options include vehicle-based, aircraft-based monitoring, and satellite monitoring, but it will be appreciate that these approaches have inherent limitations related to the use of vehicles, aircrafts, and satellites.

There remains a need in the art to improve upon air monitoring systems to facilitate monitoring of emissions over large geographical areas, with a large number of sampling locations.

### SUMMARY OF INVENTION

In accordance with a broad aspect of the present invention, there is provided a system and a method for collecting air samples from a plurality of different locations . . . .

In one aspect, the present invention comprises an air sampling system. The air sampling system comprises: a sample line for transmitting gas streams; a plurality of air sample inlets connected to the sample line; a signal gas supply connected to the sample line; a plurality of valves for regulating flow of air samples from the air sample inlets into the sample line, and for regulating flow of signal gas from signal gas supply into the sample line; at least one pump for creating a pressure differential to drive flow of air samples and signal gas in the sample line; a sensor for generating signals indicative of a gas concentration in a gas stream in the sample line; a processor operatively connected to the valves and the sensor; and a memory. The memory stores a plurality of predefined burp patterns, wherein each burp pattern uniquely corresponds to a different one of the sample inlets. The memory also stores a set of instructions executable by the processor to implement a method comprising the steps of: (a) controlling the valves to transmit, via the sample line, an air sample originating from one of the sample inlets; (b) before or after step (a) controlling the valves to transmit, via the sample line, the signal gas in accordance with the one of the predefined burp patterns uniquely corresponding to the one of sample inlets from which the air sample originated in step (a); (c) receiving and analyzing signals from the sensor to monitor the sample line for the signal gas in accordance with the predefined burp patterns; and (d) based on detection of the signal gas in the sample line in accordance with the one of the predefined burp patterns used in step (b), taking at least one related action comprising: (i) identifying the one of the sample inlets from which the air sample originated in step (a); or (ii) controlling the valves to further transmit the air sample via the sample line.

In another aspect, the present invention comprises an air sampling method using a sample line for transmitting air samples and a plurality of air sample inlets connected to the sample line. The air sampling method comprising the steps: (a) transmitting, via a sample line, an air sample originating from one of the sample inlets; (b) before or after step (a), transmitting, via the sample line, a signal gas in accordance with one of a plurality of predefined burp patterns, wherein each predefined burp pattern uniquely corresponds to a different one of the sample inlets, and the one of the predefined burp patterns uniquely corresponds to the one of sample inlets from which the air sample originated in step (a); (c) monitoring the sample line for the signal gas in accordance with the predefined burp patterns; and (d) based on detection of the signal gas in the sample line in accordance with the one of the predefined burp patterns used in step (b), taking a related action comprising: (i) identifying the one of the sample inlets from which the air sample originated in step (a); or (ii) further transmitting the air sample via the sample line.

The present invention may be used advantageously to extend the geographical range of sensors to allow for monitoring of larger areas in a cost-effective manner. Instead of having many detectors (with associated expense) spread over a large area, samples can be more conveniently collected from locations spread over the same large area, and analyzed using a single instrument. This is useful in applications where there are assets spread out over a very large area (i.e. oil sands, well sites, coal seams)

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all within the present invention. Furthermore, the various embodiments described may be combined, mutatis mutandis, with other embodiments described herein. Accordingly, the drawings and detailed description are to be regarded as illustrative in nature and not as restrictive.

### BRIEF DESCRIPTION OF THE DRAWINGS

Referring to the drawings, several aspects of the present invention are illustrated by way of example, and not by way of limitation, in detail in the figures.

FIGS. 1A and 1B illustrate plume signatures visualized in ambient H₂S concentration and wind velocity data. FIG. 1A shows a pattern of data points. FIG. 1B shows a surface representing the average concentrations over the three months.

FIG. 2 illustrates source locations triangulated and then quantified.

FIG. 3 illustrates a sample array of a network of sample inlets connected to nodes by tubing and then connected to a central monitoring system by a shared main sample line.

FIG. 4 illustrates a sample array of a network of sample inlets connected to nodes by tubing with concentration measured at the nodes and data transmitted to a central monitoring system.

FIG. 5 illustrates a sample array of a network of sample points where concentrations are measured and data transmitted to a central monitoring system.

FIG. 6 illustrates a sample array of a network of sample points where concentrations are measured and data are transmitted to a central monitoring system, and also a mobile monitor measuring concentration on a path and transmitting the data to the central monitoring system.

FIG. 7 illustrates a layout of a node to collect and transmit samples according to one embodiment of the present invention.

FIGS. 8A, 8B, and 8C illustrate example data needs of a node to collect and transmit samples according to one embodiment of the present invention. FIG. 8A shows a table of node control registers of node components including valves of a valve manifold and pumps of the node shown in FIG. 7. FIG. 8B shows a table of digital sensors of the node shown in FIG. 7. FIG. 8C shows a table of analog readings collected by nodes at different locations.

FIG. 9 illustrates a prior art valve manifold comprising a plurality of individually controllable valves.

FIG. 10 is a chart showing variability in source emission rate measured over time in an example of an air monitoring study.

### DETAILED DESCRIPTION OF EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

### Definitions

“Memory” refers to a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages.

“Processor” refers to one or more electronic devices that is/are capable of reading and executing instructions stored on a memory to perform operations on data, which may be stored on a memory or provided in a data signal. The term “processor” includes a plurality of physically discrete, operatively connected devices despite use of the term in the singular. Non-limiting examples of processors include devices referred to as microprocessors, microcontrollers, central processing units (CPU), and digital signal processors.

“Sensor” refers to a device that is operable to generate a signal readable by a processor and indicative of a concentration of a gas of interest. Non-limiting examples of sensors include gas chromatographs, and other commercially available gas detection instruments known in the art (e.g., electrochemical gas analyzers, photoionization gas analyzers, infrared gas analyzers, ultrasonic gas analyzers, holographic gas analyzers, and so forth). Non-limiting examples of gases that may be analyzed by a sensor include carbon dioxide, hydrogen sulfide, and methane.

### Overview

The present invention comprises an innovative sampling system that facilitates extending the possible reach of airborne emission surveillance to larger areas and a larger number of sample inlets. A larger number of sample inlets can be useful in increasing the resolution of emissions monitoring, and allow for monitoring of more types of gaseous compounds. For context, the present invention may be used in conjunction with air monitoring methods described below under the heading “The Monitoring Approach”) to measure plume signatures using air concentration measurements and wind data, track them back to the source location(s), and quantify them. The size of area that can be put under surveillance depends on the detection range and how far away field samples can be collected. The detection range depends primarily on the size of the leak(s), detection limit of the sensor(s), the background level of the compound(s) in question, and how many other source plumes are in the area. The present invention may draw samples (e.g., under vacuum) from remote sample inlets back to central monitoring equipment. Under the current state of the art, the furthest away a sample can be effectively drawn down a single line is 1 to 2 kilometers (depending on sample line diameter).

Normally, the present invention can readily identify rogue sources both at a facility, and a few kilometers away therefrom. But sometimes, an identified plume signature overlaps unrelated signatures of a similar size. This can be due to separate leaks at a facility being of similar size, or huge areas under surveillance where plumes have travelled great distances. In this case, a faster and more powerful analysis is required to isolate plume signatures from a source with many other similar sized plume signatures present. Improving the detection limit of plume signatures will beneficially increase the distance from which sources can be observed. Signatures can be identified more quickly on emerging sources because less data are needed (thereby reducing the time taken to collect and analyze such data), and signatures can be isolated from each other with greater accuracy in situations where many sources are present.

In one aspect, a goal of the present invention is to drive down the cost of emissions surveillance of huge areas by increasing the range of detection. In other aspects, goals of the present invention are to improve the sensitivity of analysis using innovative approaches to deploying sensing instruments, combined with significantly improved automation of data analysis (including the use of, for example, machine learning, distributed computing, edge computing, advanced statistics, cloud computing, and improved human-computer interfaces).

### The Monitoring Approach

Monitoring approaches that can be implemented with the air sampling system and method of the present invention are described in U.S. Pat. Nos. 7,523,638, 7,743,643, 7,934,412, 8,510,059, and 8,949,037 (2015 May 23), Canadian patent no. 2,476,902 (2009 May 28), and International patent publications no. WO2008086606 A1 (2008 Jun. 24), and WO2010118500 A1 (2010 Oct. 21), the entire contents of which are incorporated by reference herein, where permitted. For convenience, any one or more of such monitoring approaches may be referred to herein as “Airdar monitoring”.

Airdar monitoring includes technology referred to as air detection and ranging. Airdar monitoring involves intercepting emission plumes far from the sources and at low concentrations, thus enabling continuous leak detection covering large areas using an array of stationary (or mobile) sampling points. Automated, low concentration air sampling on the fence line and other locations on a site combined with Airdar monitoring can meet and exceed regulatory leak detection and fence line monitoring objectives with unattended operation. Airdar monitoring can use any commercially available sensors (e.g., monitors and gas chromatographs (GCs)) in various combinations so that most airborne compounds can be monitored.

Airdar monitoring delineates fugitive emission plume boundaries of any detectable airborne compound (including H₂S, methane, benzene, etc.) using only ambient air concentration and wind data. It is important to note that the Airdar monitoring is different from inverse dispersion modeling. Dispersion modeling alone is complex, requiring assumptions of dispersion coefficients followed by modeling what the plumes will do into the future (forward in time). Inverse dispersion modeling is even more complex, modeling into the future and then the past. Understandably, this process has struggled with biases. Airdar monitoring avoids the inherent weaknesses of dispersion modeling by only measuring plumes back in time and by not requiring the use of assumed dispersion coefficients. The result is increased accuracy and reliability. Airdar monitoring tracks plumes of fugitive emissions back to their sources, identifying the sources from a significant distance (up to several kilometers away). Additionally, the Airdar monitoring may accurately quantify the actual emission rate of each source. This is all done at a distance, possibly using only ambient data on airborne compound concentrations and wind velocity.

The following series of formulas are used to quantify source emission rates using ambient concentrations.

Flux=Air Concentration×Wind Speed Equation 1: Emission Flux
Where:
Flux=movement of a compound per unit cross-sectional area of the plume with units

$$\frac{m}{{l}^{2} t} ;$$

Air concentration=Air concentration of a compound with units

$$\frac{m}{{l}^{3}} ;$$

Wind speed=Speed of the wind moving the air measured with units l/t;
m=Mass;
l=Length; and
t=Time.

Source Emission Rate=Flux×Plume Cross-sectional Area Equation 2: Emission Rate
Where:
Source Emission Rate=rate the compound is released to the atmosphere with units m/t; and
Plume Cross-sectional area=the cross-sectional area of the plume sliced perpendicular to the wind with units l².

This multiplies the flux by the cross-sectional area of the plume to obtain the source emission rate. This second equation is straight forward when calculating the flow in a pipe because the cross-sectional area of the pipe is known and unchanging. The challenge in applying this formula to calculate the flow rate of compounds in plumes that travel in air, is measuring the cross-sectional area of the plume, which is continuously changing its position and size as the wind changes. Airdar monitoring overcomes this challenge with an approach of measuring the plume characteristics in terms of (or in reference to) the wind velocity.

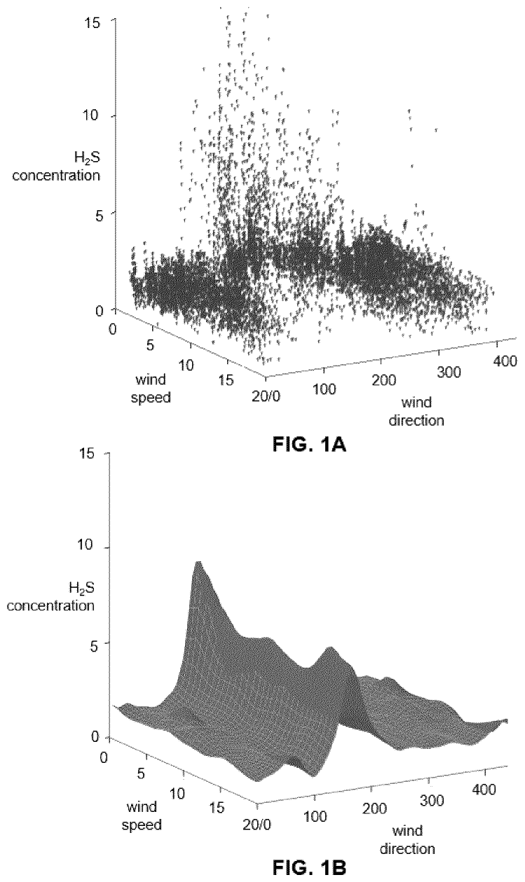

Airdar monitoring can delineate plume signatures (i.e., a dimensionless plume, the essence or characterization of a plume) using ambient concentration data and wind velocity in order to measure plume area. As an example, FIGS. 1A and 1B show that plume signatures are evident in plots of H₂S concentration data collected over 3 months at one single location at the Fish Creek Wastewater Treatment Plant (WWTP) (plotted against wind speed and direction). The pattern in the data points in FIG. 1A reflects the sources causing the H₂S levels. FIG. 1B is a surface representing the average concentrations over the three months that shows a plume signature more clearly as a ridge along a certain wind direction (plume trajectory). These figures show that plume boundaries and trajectories can be identified in ambient concentration and wind velocity data.

Converting these dimensionless plume signatures to scalar plume dimensions requires knowledge of the distance from the source position to the observation position. Equation 3 provides a relationship to convert dimensionless or angular plume width to scalar plume width using distance from the source to the observation position. The vertical height of the plume can either be assumed (based on the horizontal dimension), or measured using observation positions at different heights or using the changing plume height at different wind speeds. With this approach, even a single observation position can quantity a source if the distance to the source is known. When dealing with fugitive emissions, the source locations are initially unknown and requires at least two observation positions to first triangulate the source location and then scalarize the plumes to calculate emission rates.

$$Plume Width = \frac{Plume width * 2 π r}{360} \qquad Equation 3$$

Where:
Plume Width (m)=the horizontal width of a plume measured in meters (actually the arc length);
Plume Width)(°=the horizontal width of a plume measured in degrees; and
r=the distance between the source location and the location where the air concentrations were measured.

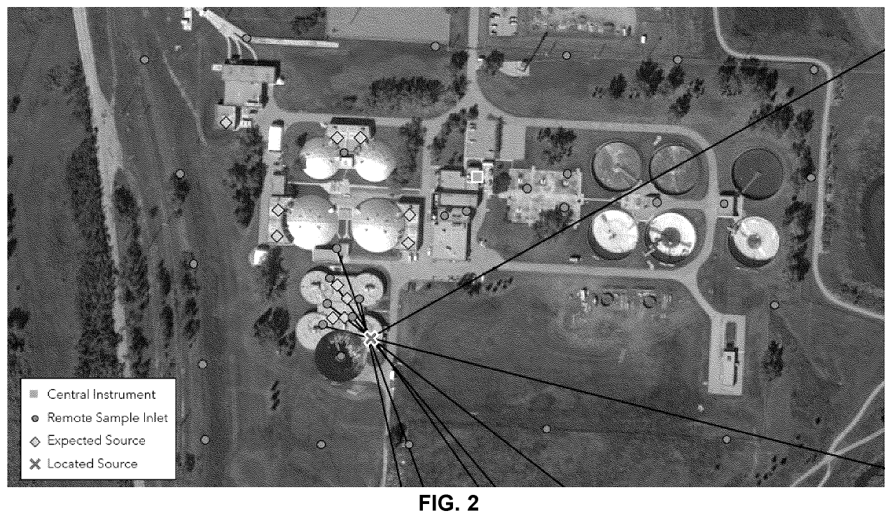

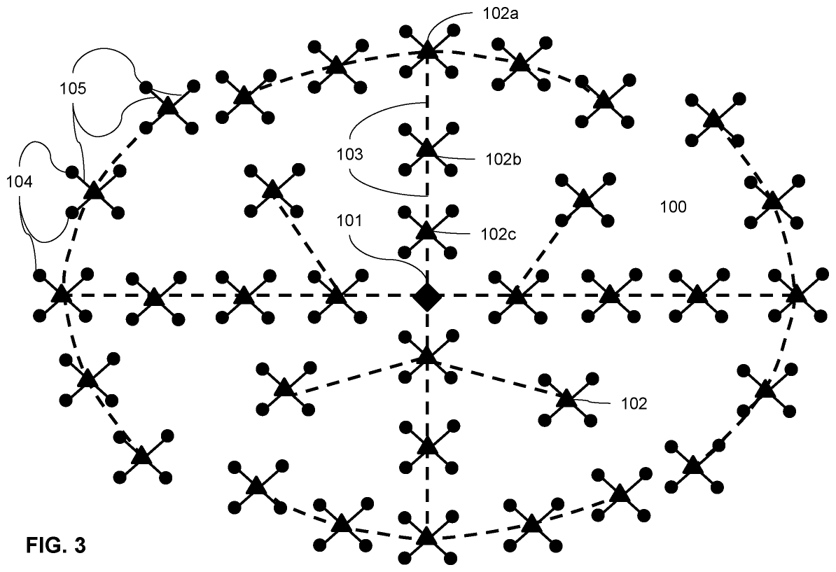

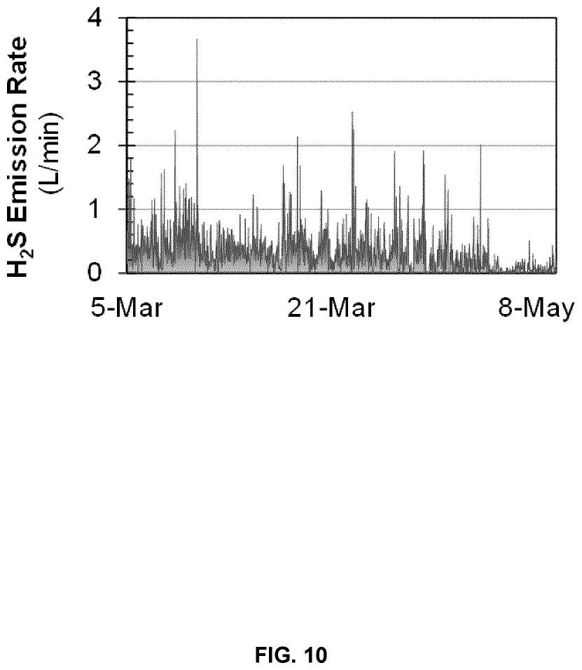

FIG. 2 shows how an unknown source was located using triangulation of the plume trajectories (orange lines) observed at multiple observation positions. Once located, the distance to the source was used to determine the plume area and quantify the source emission rate. The variability in the source emission rate can be measured over time as shown in the chart included in FIG. 10.

Airdar monitoring can monitor fugitive emission sources remotely, using only ambient measurements of gas concentration and wind. Airdar monitoring enables fugitive emission surveillance to become unattended and 24/7 through automated ambient sampling in and around a site. It can also meet and exceed regulatory fence line monitoring objectives. 24/7 fugitive emissions surveillance can improve an operator's management of emissions by helping them to understand all of the important emission sources on or near their sites. Not only can this approach reduce human resources spent on current monitoring, but it can significantly reduce or eliminate large financial investments that are sometimes spent to intervene/respond to emission issues that are misunderstood. It can be wasteful making investment decisions to address emission issues based on uncertain or incorrect information about emission sources. Airdar monitoring can make fugitive emission and fence-line monitoring more efficient through automation, but most importantly it can solve emission problems by removing uncertainty, and allowing problems to be confidently and completely addressed.

### Air Sampling System and Method

To implement Airdar monitoring, and or air monitoring methods, a system is needed to collect air samples at many dispersed locations for surveillance of all important emitting sources over huge areas. The system would need the correct spacing and detection limit of sensors to ensure leaks of the minimum target size will be detected by the system.

The sensors could be mobile, located at fixed locations, and/or have an array of remote sample inlets where they draw samples back to a central sensor. The sensors could be independent sensors communicating with the cloud or relaying signals back to other sensors which relay them back to a central processor. These data could be processed at the edge (on-device), at distributed “hubs”, or in the cloud. Sensors could be independent and/or collect samples from a local array. Depending on the compound in question and expense of a sensor with an appropriate detection limit, there may be the need to pass a sample a great distance back to a central instrument set for sensing/compound detection.

Sensors with detection limits below the background concentration of a compound in question are preferred, but the system can use data from sensors with higher detection limits, at the cost of limiting the range at which plume signatures from sources can be identified. Accordingly, in one embodiment, existing sensing networks for occupational health and safety purposes (with higher detection limits) can be used in an approach to monitor sources.

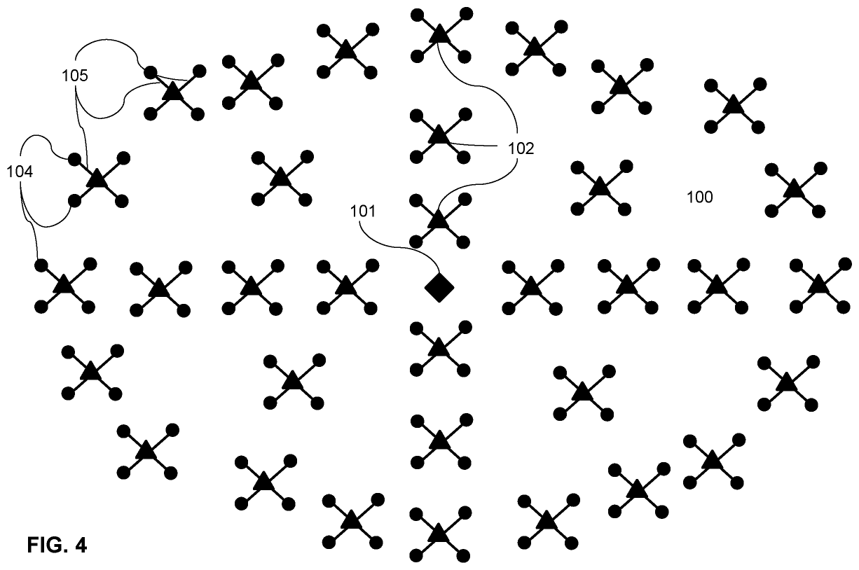

FIG. 3 shows an array of remote sample inlets some of which share a common sample line back to a central instrument cabinet for analysis by sensors. For example, FIG. 3 may be a huge area 100 with a sampling array consisting of a central instrument cabinet 101 that houses sensors, pumps, valve manifold, and controller capable of collecting samples from nodes 102 which are connected by a main sample line 103. In this way, a large area can be monitored using a small number of sensors at the central instrument cabinet 101.

The nodes 102 are further connected to local sample inlets 104 by sample lines 105. The sample inlets 104 can be at different heights. The system is not limited by any particular minimum or maximum distance between the nodes 102 and the central instrument cabinet 101, between one node 102 and another node 102, or between one sample inlet 104 and another sample inlet 104. For example, if the nodes 102 are roughly 2 kilometers apart then FIG. 3 covers an area 100 of 192 km²; if the nodes 102 are 5 kilometers apart; then the area 100 is 1200 km². For example, the local sample lines 105 could be up to 1 to 2 kilometers in length depending on the strength of the vacuum pump and the diameter and smoothness of the sample line 105. The distance between the nodes 102 on the main sample line 103 is only limited by the sample flow needed, the pump pressures (vacuum from downstream node and pressure from upstream node), and main sample line 103 diameter and smoothness. For example, such distance could be up to 5 kilometers between nodes 102.

One innovative aspect of this system is the use of nodes 102 to relay samples over large distances. Sampling array will consist of sampling nodes 102 connected together on a common main sample line 103 at intervals. One of the nodes 102b (referred to herein for convenience as an “downstream node”) will either relay a sample from an upstream another node 102a (referred to herein for convenience as an “upstream node”) down the main sample line 103 toward central instrument cabinet 101, or collect a sample from one of a number of its local sample inlets 104 (i.e., of node 102b) by lines 105 and send the sample down the main line 103 toward central instrument cabinet 101, possibly via another one of the nodes 102c. The movement of samples is effected by pressure differential created by pumps at the nodes 102. To perform these two functions, each node 102 houses one or more vacuum and/or pressure pumps. In one embodiment, when a sample travels from node 102a to node 102b through the main sample line 103, there is a vacuum from the downstream node 102b and positive pressure from the upstream node 102a, whereas a sample traveling from a sample inlet 104 to a node 102 through a local sample line 105 may only be subjected to vacuum.

FIG. 4 shows a sampling array where the nodes 102 are not connected by a main sample line 103 and the compound analysis is done by sensors at the nodes 102 with the results transmitted back to the base (i.e., central instrument cabinet 101) via a communications network.

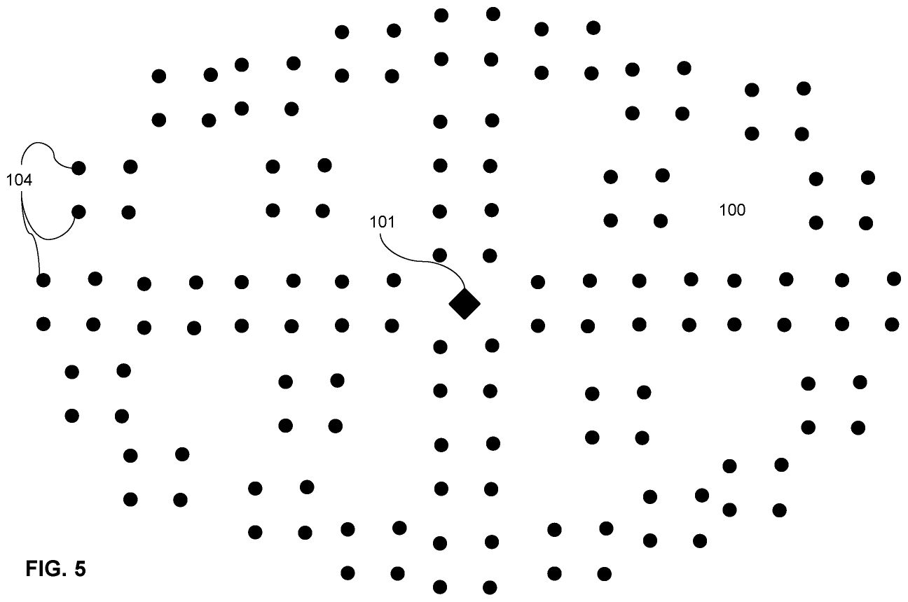

FIG. 5 shows a sample array with no nodes 102 where the compound analysis occurs at the sample point with results transmitted via a communications network back to base (i.e., central instrument cabinet 101).

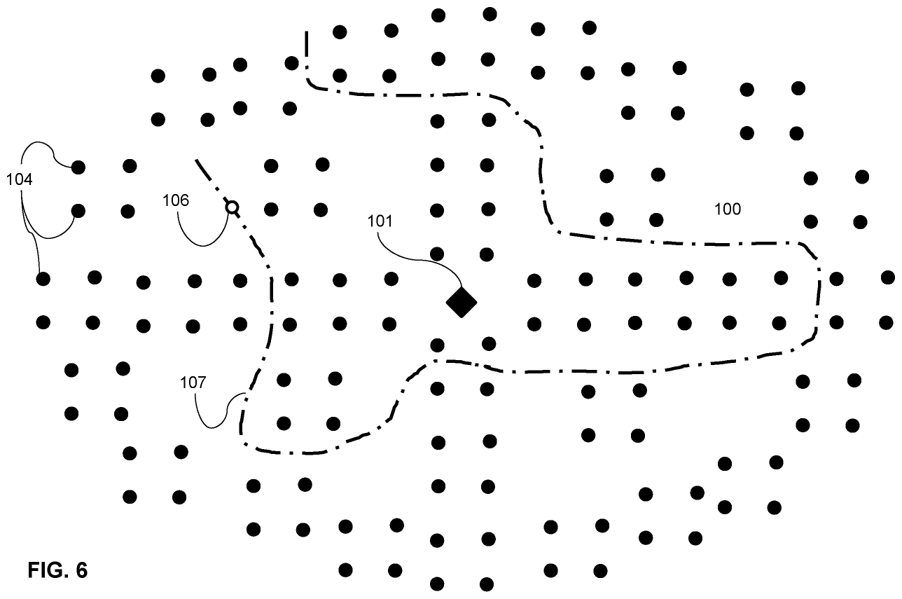

FIG. 6 shows a sampling array that includes a mobile monitor 106 traveling a path 107 and transmitting the information on concentration, position, and time back to the base (i.e., central instrument cabinet 101).

Any combination of the of the mobile, sample node, and base analysis of the compound in question is possible including some compounds analyzed in one location while others are analyzed in other locations.

### Node

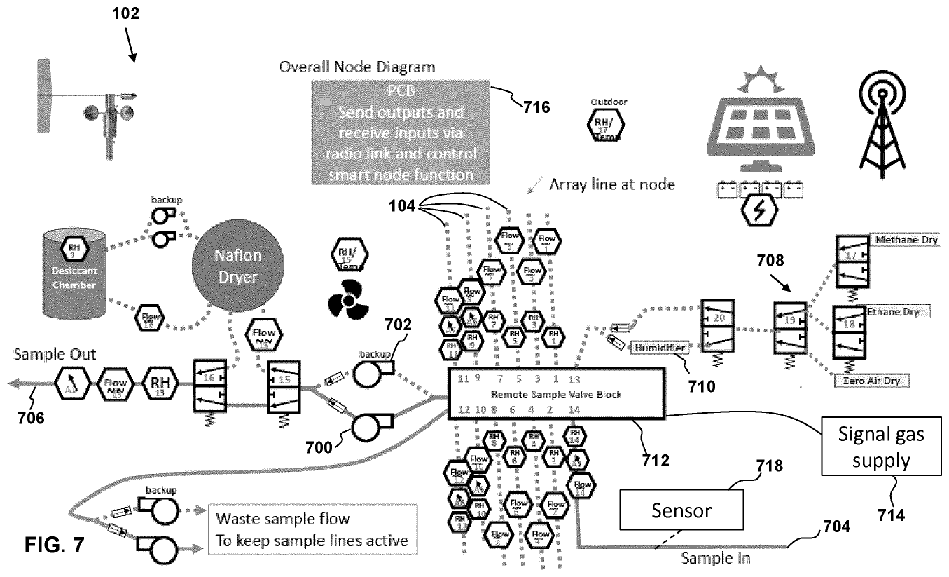

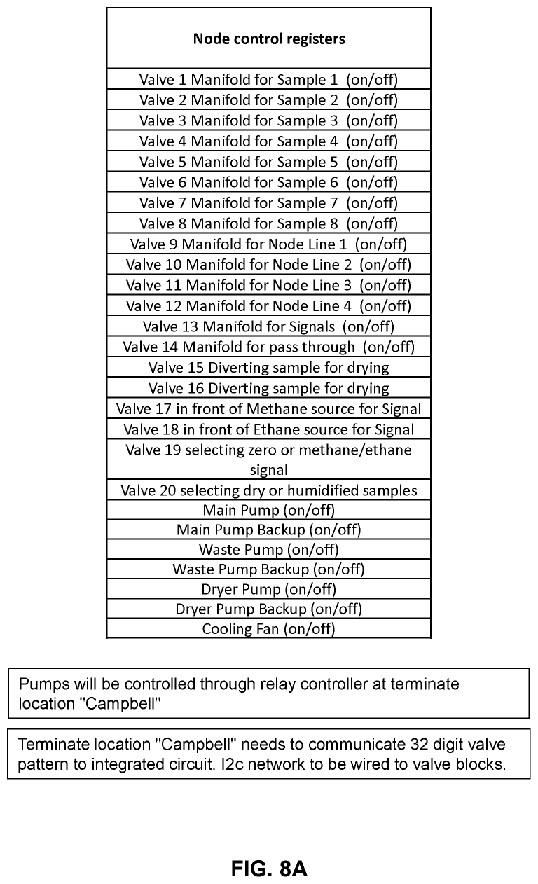

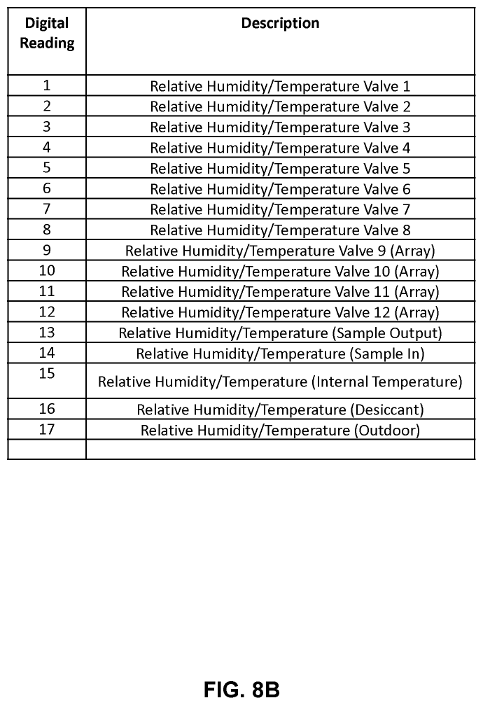

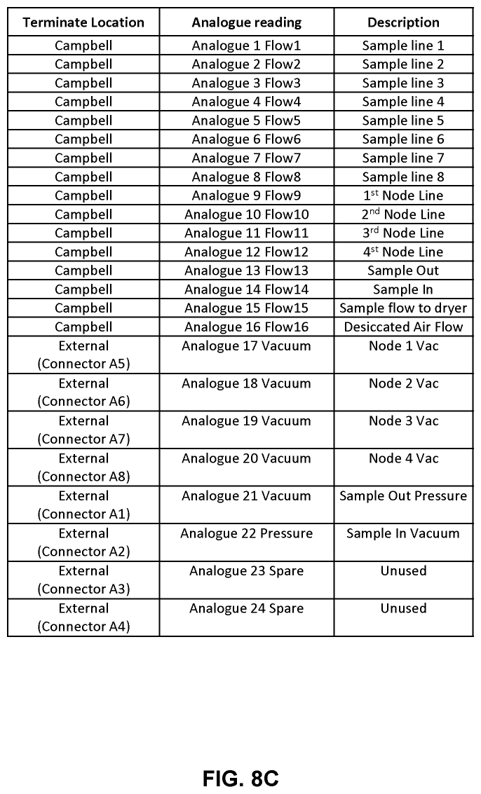

The following are details of the nodes 102 in terms of their functioning and components, which are also shown in FIGS. 7 and 8A to 8C. In the table of FIG. 8A, the numbering of the valves corresponds to valve numbers used in the “Remote Sampling Valve Block” and components shown by valve symbols in FIG. 7. In the table of FIG. 8B, the numbering of relative humidity/temperatures sensors under the column labelled “Digital Reading” corresponds to the numbering of components labelled “RH” in FIG. 7.

The pumps (e.g., pumps 700, 702 and other pumps shown by similar pump symbols) and sample tubing (e.g., tubing 704, 706 and other tubing between components) may be of a design and material so as not to interfere with the concentration of the compound of interest. A main pump (700) and backup pump (702) may be used to propel the air samples received from main sample line 103 via tubing 704 or from sample inlets 104 via local sample lines, toward sample tubing 706 that connects to main sample line 103, leading to either another node 102 or central instrument cabinet 101 of a sampling array such as shown in FIG. 3.

The sample may be dried (have excess moisture removed) to the extent necessary so that water does not condense in the main sample line 103. The drying system 708 may only operate on samples being drawn from the local sample lines 105 as relayed samples received from another node 102 should already be dried. Alternatively, the sample may be humidified by a humidifier 710.

Nodes 102 may have a signal gas system capable of sending a unique pattern of one or more burp(s) (i.e., discrete injection(s)) of a signal gas down the main sample line 103. The signal gas system and its usages are described in further detail below under the heading “Signal Gas System and Methods.”

The node 102 may have valve manifold 712 capable of sending a sample from an upstream node 102 or local sample inlets 104 to the pump 700 that will propel it to a downstream node 102 or to gas sensors of central instrument cabinet 101, or to send signal gas to this pump 700. This valve manifold 712 may energize one of the valves when the sample is to be drawn from one of the local sampling inlets 104. The sample coming from an upstream node 102 will be wasted when a sample from a local sampling inlet is used. The valve manifold 712 may also be able to control which valves are used based on a received signal gas pattern as described below.

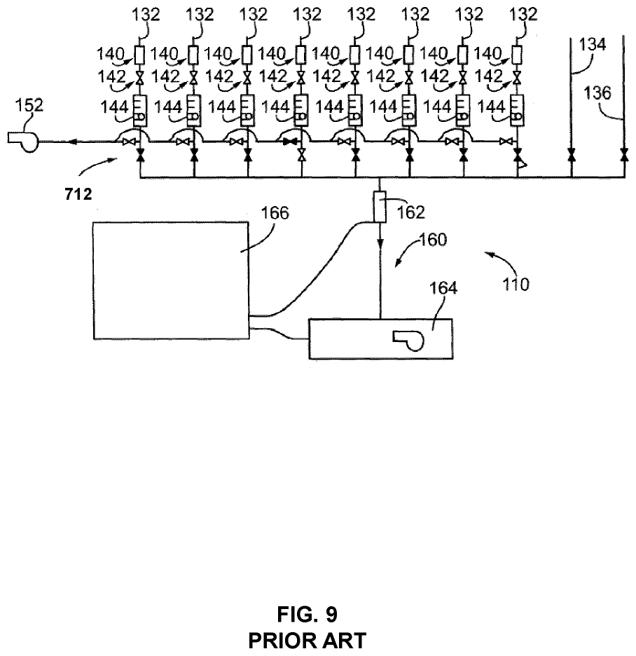

It will be understood that the valve manifold 712 comprises a plurality of valves that may be selectively opened and closed to control flow of air samples and signal gas from the valve manifold 712 to the pump 700. For illustrative purposes, FIG. 9 shows an example of a prior art valve manifold 712 described in U.S. Pat. No. 8,949,037, which may be adapted for use in the present invention. The valve manifold 712 includes a plurality of valves 142 for controlling the rate of air intake in association with sample lines 132, zero line 134 for supplying zero gas, span line 136 for supplying gas of a known concentration of a contaminant, filters 140, flow rate sensors 144, vacuum source 152 for maintaining a constant flow to deliver fresh air samples down the sample lines 132, sample analysis stream 160, flow meter 162, a controller 166 for actuating valves of valve manifold, and an analyzer 164 at an equipment package 110.

The nodes 102 may have local sensing, such as RH or temperature to check the effectiveness of the drying system.

The node 102 may be configured to communicate with the central equipment cabinet 101 either by radio, cellular, or fiber optic lines to get instructions on what valves to switch and also provide feedback on any sensing done on the nodes.

Nodes 102 may generate their own power using solar sets.

Nodes 102 may measure wind velocity using a wind sensor.

Nodes 102 can have pumps for samples and waste pumps to keep unused sample line active as well as pumps for the drier. There can also be backup pumps available with one-way check valves in case a pump fails it can be switched to backup without the system going down.

Nodes 102 can have indoor and outdoor sensors for relative humidity.

Nodes 102 can have a Nafion™ dryer connected to desiccant to remove water from the sample line 103 without removing the samples of interest for analysis.

Nodes 102 can have custom controllers built-in to send outputs and receive inputs via radio link and control node function.

Nodes 102 can have pressure sensors on the outgoing sample line 706 and vacuum sensors on the incoming lines 704 to make sure pumps are providing the appropriate amount of suction or pressure on the samples being moved.

Nodes 102 can have radios, cell connection, or fiber optic lines for communicating with the central instrument cabinet 101.

Nodes 102 can read analog or digital sensors and communicate information about valve positions and sensor outputs by registries shared with the central instrument cabinet 101.

Nodes 102 can have flow sensors on the lines to ensure the lines are moving the samples (e.g., no failed pumps or broken lines). The flow sensor output can also be used to predict the time of travel of the samples down the sample lines 105.

A smart sample node 102 may pump a sample back to the main central instrument cabinet 101.

The smart node 102 may be configured to send and receive data over wireless radio network based at the main central instrument cabinet 101. For example, radio network may include one base station and 8 remote smart nodes at a max distance of 6-8 km, for example 7 km, from the base (central instrument cabinet 1010) to the furthest node 102. Data may be sent and/or received periodically, for example every second.

The input information received from the central instrument cabinet 101 may specify where to take the sample and which pumps and valves to actuate.

The node 102 may output information and send it back to the central instrument cabinet 101 including readings from sensors on flow, RH, pressure, battery voltage, solar charging, wind, and node temperature.

The node 102 may draw the sample from an array of local sample inlets 104 (e.g., up to 8 per node), or relay a sample that another smart node 102 has pushed to its location.

A main pump 700 and backup pump 702 may be used to push the sample. The backup pump 702 may be configured so that it will start (and a valve will switch the lines) if the main pump loses pressure or flow rate drops. If the backup pump 702 starts then a message may be sent to notify operators that there is a pump problem.

An optional pump with backup is possible to keep the array of local sample lines 105 flowing when they are not being used to send a sample down the main sample line 103. Alternatively, if these lines are short they may be left without flow when they are not used.

The sample may be dried (water removed) so water does not condense in the sample lines. If the smart node 102 is drawing the sample locally then the sample may be routed through a Nafion™ dryer before its leaves the sample node.

A smaller pump with backup may be used to cycle dry air from a desiccant column through the Nafion™ dryer in a counter flow direction to the sample to remove water from the sample.

Flow rates on the sample lines may be measured on the main sample lines 704, 103 entering the node 102 from an upstream node 102 and leaving the node 102 to a downstream node 102. The option is available to monitor flow rates on the local sample lines 105.

There is an option to measure wind speed and direction at the smart node 102. A data input of wind speed and direction needs to be received and averaged (vector average for wind direction) relevant to each sample at or near to the sample inlet or the smart node. The wind speed and direction reading must be included in the output data sent from the smart node 102 back to the central instrument cabinet 101, or collected in a way that is relatable to the output data.

The node 102 may be powered by a solar panel and battery system or AC power. Battery voltage and solar charging will be measured and sent in the output data to the central instrument cabinet 101.

Node 102 enclosure temperature will be measured and sent the central instrument cabinet 101. If temperature is high, then a fan will be started to circulate air to cool the enclosure. If temperature is low, then heat from the pump chamber can be used to maintain warm temperatures.

Relative humidity (RH) on the sample lines may be measured on the main lines entering the node 102 from an upstream node 102 and leaving the node 102 to downstream node 102. The option may be available to monitor flow rates on the local sample array lines 105. RH may also be measured in the desiccant chamber and a message will be sent to operators when RH increases in the desiccant chamber as an indication that the desiccant needs to be replaced.

### Signal Gas System and Method

As noted above, each node 102 may include a signal gas system that is capable of sending a unique pattern of one or more burp(s) (i.e., discrete injection(s)) of a signal gas down the main sample line 103. In brief, the signal gas system can be used for at least two purposes: identification of a node 102 from which an air sample originated; and controlling a downstream node 102 to relay an air sample toward another node 102 or central instrument cabinet 101.

The present invention is not limited by the composition of the signal gas, but for reasons that will be apparent, the signal gas is preferably of a precisely known composition and concentration. As non-limiting examples, the signal gas may be methane or ethane having a concentration of 100 ppm. The signal gas may be a calibration gas (also referred to as a span gas)—i.e., a gas that has a known concentration of a compound. Or, the signal gas may be a zero gas—e.g., high purity nitrogen that is not expected to have any trace of a target gas in the air sample to be analyzed. Or, the signal gas may comprise a compound that is expected to be present in the air samples under analysis, but at such higher concentration that the pattern of burps will still be distinguishable.

Referring to FIG. 7, the signal gas system comprises a signal gas supply 714, at least one valve for regulating injection of the signal gas into main sample line 103, a computer device 716, and a sensor 718.

The signal gas supply 714 may be a vessel storing the signal gas. The valve for regulating injection of the signal gas into main sample line 103 may be a valve 142 of valve manifold 712 associated with zero line 134 or span line 136, as shown in FIG. 9. The sensor 718 is used to generate signals indicative of a gas concentration in a gas stream in the sample line. In FIG. 7, for example, sensor 718 is connected to incoming tubing line 704 that is connected to main sample line 103.

The computer device 716 is operatively connected to the valves of the valve manifold 712 so as to be able to actuate the valve using electronic signals. The valves may be actuated with solenoids responsive to electronic signals, as known in the art. Referring to the embodiment of FIG. 7, the computer device 716 is represented by printed circuit board (PCB). It will be understood that the computer device 716 includes a processor and a memory. Each of the processor and memory may comprise one or more physically discrete component(s). Such components may be located at a node 102, or remotely from node 102 (e.g., using cloud computing or distributed computing systems), or a combination of both.

The memory stores a predefined set of burp patterns, with each pattern uniquely corresponding to one or more sample inlets 104 of a node 102. For example, a unique burp pattern may correspond to all the sample inlets 104 of a node 102a, while another unique pattern may correspond to all the sample inlets 104 of a different node 102b. Or, a unique burp pattern may be associated with each sample inlet 104 of one node 102.

A burp pattern may be defined by one or more of the following parameters: the number of burps; a time duration of each burp; a time duration of an interval between each burp; or a sequence of burps having different signal gas compositions. For example, a first burp pattern of signal gas may consist of two burps; a second burp pattern of signal gas may consist of two short duration burps followed by a long duration burp; a third burp pattern of signal gas may consist of one long duration burp followed by two short duration burps. As another example, a first burp pattern may consist of two burps of methane; and a second burp pattern may consist of a first burp of methane, and a second of ethane. When such different burp patterns of signal gas are detected by a sensor and analyzed, they will exhibit different patterns of peaks of signal gas concentration that are distinguishable from each other.

The memory also stores instructions executable by the processor(s) of nodes 102 and/or central instrument cabinet 101 to implement a method of the present invention, as follows.

Referring back to FIG. 3, the processor may control valves of valve manifold at a node 102a to send a burp patterns of signal gas down the main sample line 103 to a node 102b, or from node 102b to the central instrument cabinet 101. This may be performed at the beginning or end of sampling period for the node 102 or between switching of local sample lines 105 for different sample inlets 104. The sensors at the downstream node 102b, or the central instrument cabinet 101 will detect the burps in the gas concentration coming down the main sample line 103, and the processor then analyzes the detected burps, and identifies the associated node 102 based on the stored burp patterns (e.g., by matching detected burps with one of the stored burp patterns). The present invention is not limited by when this analysis to identify the node based on burp patterns is performed relative to data collection. It could be performed in real time near the time of data collection or well afterwards, depending on the reason for identifying the node from which the air sample originated.

The identification of the node 102 can be used to confirm that there has been a valve change in the valve manifold 712 in the manner expected. This may promote confidence in sample continuity constantly and provide a degree of certainty as to where the sample came from. Inconsistency between the identified node 102 and another node 102 that was expected to be the source of an air sample may indicate that a sample line has been broken, the valve manifold 712 is not functioning properly, or the integrity of the air monitoring system has been compromised in some other way, that is causing the sample to come from a location that is different from the expected location.

The detection of a burp pattern of signal gas can also be used to control the valve manifold 712 at a receiving node 102. For example, referring to FIG. 3, in response to detecting a burp pattern of signal gas at node 102b, the processor may control the valve manifold 712 and pump 700 at node 102b so as to relay the air sample received from node 102a down the main sample line 103 to node 102c, rather than to a waste stream.

### Computer Implementation

Automation, and advanced control, computing, and analysis (e.g. machine learning, distributed computing, edge computing, advanced statistics, cloud computing, improved human-computer interfaces, etc.) can be used in a number of loops within the present invention as well as combination of some or all of these loops in a large outer loop that estimates source characteristics (including location) based on agreement and then adjusting settings (ranges) and repeating the method to collect additional data and analyze same for convergence to obtain better supported source estimates. The following are activities that can be so automated:
(a) identifying plume signatures in baselines (requires range assumptions);
(b) isolating plume signatures from other plume signatures (how to group the plume signatures to get the best result);
(c) combining plume signatures from multiple observations to identify sources (use machine learning to find best fit in less time and without considering all combinations which may become impossible);
(d) identifying signal gas burps in instrument output (improving time of travel estimate down the sample line will improve accuracy of source locating);
(e) using machine learning to teach the computer how to identify plume signatures for mobile sensors;
(f) using machine learning to teach a computer how to find plume signatures in data by using plumes from known sources of compounds and then removing these known sources and looking for plume signatures from unknown sources (this can be an iterative process where unknown sources are identified and then removed from the data as known sources and then more unknown sources are looked for);
(g) identifying sources and adjusting ranges recursively to see it estimates improve in agreement;
(h) correlating plume signatures across wind speeds to enhance plume identification;
(i) correlating plume signatures across wind speeds to identify geographical features affecting air movement;
(j) correlating plume signatures across wind speeds and directions to determine plume dimensions;
(k) correlating plume composition (compounds present and their relative concentrations) to enhance plume identification and parsing from overlapping plumes;
(l) correlating applied emission rates to enhance source location;
(m) using known sources to auto-correct wind instruments;
(n) identifying area sources (ponds, swamps, dumps, geological formations);
(o) correlating new sources with seismic activity (fracking, earthquakes, volcanoes);
(p) integrating satellite info to enhance plume and source location analysis;
(q) learning best distance from source for each plume through recursive analysis (plumes should tend to come into better focus when the true distance to the source is used as an input to wind smoothing);
(r) characterizing area sources (emission sources emanating from a geographic area such as a pond or swamp, as opposed to point sources which are considered to emanate from a single geographic point) using recursive best fit analysis to learn the dimensions of the area emission surface;
(s) calculating the implied emission rate for an area using the area emission surface;
(t) adaptive validation of calibration cycles;
(u) adaptive analysis of gas chromatograph (GC) output to correctly identify compounds GC behavior changes over time; and/or
(v) geographic binning of measurements and/or emission rates to enable source location over larger geographic areas.

### Graphical User Interfaces

An interface, such as a browser-based dashboard interface, may be provided for a human to interact with the process to influence the plume signatures modeled and selected for source identification. Machine learning may be used so a computer can learn how to implement the human corrections to the process. The emission rate over time charts are updated in near real-time. The dashboard may also communicate information to operators of clients.

Alarms can be provided via email, phone call, text, dedicated interface, or through the web dashboard. The alarms can be triggered by a single reading being outside the alarm limits which will be wind speed and direction dependent. The trigger point can be based on several standard deviations of the historical data. The alarms can be verified by a technician before they are sent to the client. Alarms can also be triggered by a pattern of readings that is evidence of an important source rather than just one reading.

Real-time known source emission rates updating involves processing the new data and determining if the reading resides in an existing plume signature that has been identified with a source. For readings which reside in plume signatures from existing sources, the emission rate chart of the source is updated with the new reading.

An expanded set of compounds (25 total) using a gas chromatograph (GC) with intermittent sampling requires coordinating the GC triggering and results reporting with the continuous monitors.

### Application to Monitoring of Fluids Generally

The foregoing description described aspects of the invention as applied to air monitoring. However, the invention could as well be used to sense and locate contaminants in any flowing fluid and is not limited to air monitoring.

### Experimental Test Results

During testing, the present invention was found to be effective at locating sources both at a facility and 3 to 5 kilometers away. It can track plume signatures from a very large source (e.g. a flare stack) 15 to 20 kilometers away. The plume signatures from the top 5 to 10 largest sources at a facility are clearly evident above the thousands of background sources. This is possible because fugitive emissions are not normally distributed; they are highly skewed distributions where the largest “rogue” sources are much larger than they should be. In fact, if the fugitive emissions at a facility are normally distributed, or even log-normally distributed, that may indicate that the facility does not have a fugitive emission problem.

The following paragraphs describe two test studies done by Golder Associates in partnership with Airdar. The first demonstrates how the present invention locates and quantifies fugitive sources of H₂S at the Fish Creek Wastewater Treatment Plant (WWTP) in Calgary Alberta. The test identified important emission sources on-site but, more importantly, determined that the actual sources causing perceived odor in the community were located 2.5 kilometers off-site. The test included real-time surveillance of fugitive emission sources and fenceline monitoring at the Fish Creek WWTP. The second study included results of 24/7 fugitive emissions monitoring at an oil production facility.

### Study #1

Due to close proximity to residential communities, the Fish Creek WWTP receives a considerable number of odour complaints. Test embodiment provides real-time monitoring, location, and quantification of both onsite and offsite H₂S emission sources. The test embodiment identified an important source onsite in an unanticipated location but determined that onsite sources were not causing the odour problem in the community. The system also identified important offsite sources kilometers away that were the actual cause of the odour in the community. The test embodiment may be able to provide real-time alarms to management teams if the facility is releasing enough H₂S to cause odour in the community.

### Study #2

Another embodiment was tested to gain a better understanding of emission sources of total hydrocarbons (THC) and H₂S at an oil production facility. In the course of the experiments, the facility expanded the sampling array and installed monitoring equipment. The test embodiment identified unsuspected important sources of H₂S at the wastewater treatment facility offsite and allowed management teams to prioritize emissions management actions on-site. The test embodiment provides continuous quantification of important fugitive emission sources onsite and offsite and measures progress of emission reduction efforts. The following compares the results to other traditional leak detection surveys that occurred concurrently.

### Clauses

1. Apparatus and method to measure air concentrations of compounds independent of distance to support the analysis of sources
2. A sampling system capable of relaying air concentration measurements over repeater stations or cell networks to a central station or to the cloud for analysis
3. A sampling system capable of relaying air samples from remote sample inlets to a central station for analysis or to the cloud for analysis, including any one or more of:
   (a) Apparatus and method that uses a common shared main sample line;
   (b) Apparatus and method that uses separate sample lines for each sample location;
   (c) Apparatus and method that draws the samples by vacuum;
   (d) Apparatus and method that pushes the sample down the line with pressure;
   (e) Apparatus and method that removes water from the sample to avoid condensing in the sample line if pressure is used to drive the sample;
   (f) Apparatus and method to send unique signals of known gas concentrations to identify the sample in the shared sample line so the location the sample originated at is known and sample line integrity is confirmed; and
   (g) Apparatus and method with sensing (flow, pressure, RH, air concentration) in the nodes or sample location to confirm sample identity and system continuity.
4. Automated series of steps that loops through the entire Airdar method and estimates source locations and then adjusts parameters based on estimated source locations and runs the system again and again converging on the correct sources and quantifying them, including any one or more of:
   (a) Automated plume signature analysis and identification in raw data of concentration and wind velocity;
   (b) Automated plume signature analysis in a series of steps that can converge on the correct sources causing the plume signatures;
   (c) Automated sample system identification based on signals gas patterns sent from remote monitoring locations;
   (d) Automated series of steps to separate plume signatures that are converging together;
   (e) Automated series of steps to characterize patterns in area sources;
   (f) Automated series of steps that identifies sources and removes the associated plume signatures so that further analysis can find small less obvious plume signatures and sources; and
   (g) Automated series of steps that set Airdar apparatus parameters based off a known source causing plume signatures at sample inlets.

### Interpretation

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. An air sampling system comprising:
a sample line for transmitting gas streams;
a plurality of air sample inlets connected to the sample line;
a signal gas supply connected to the sample line;
a plurality of valves for regulating flow of air samples from the air sample inlets into the sample line, and for regulating flow of signal gas from signal gas supply into the sample line;
at least one pump for creating a pressure differential to drive flow of air samples and signal gas in the sample line;
a sensor for generating signals indicative of a gas concentration in a gas stream in the sample line;
a processor operatively connected to the valves and the sensor; and
a memory storing: a plurality of predefined burp patterns, wherein each burp pattern uniquely corresponds to a different one of the sample inlets; and a set of instructions executable by the processor to implement a method comprising the steps of:
(a) controlling the valves to transmit, via the sample line, an air sample originating from one of the sample inlets;
(b) before or after step (a), controlling the valves to transmit, via the sample line, the signal gas in accordance with the one of the predefined burp patterns uniquely corresponding to the one of sample inlets from which the air sample originated in step (a);
(c) receiving and analyzing signals from the sensor to monitor the sample line for the signal gas in accordance with the predefined burp patterns; and
(d) based on detection of the signal gas in the sample line in accordance with the one of the predefined burp patterns used in step (b), taking at least one related action comprising:
(i) identifying the one of the sample inlets from which the air sample originated in step (a); or
(ii) controlling the valves to further transmit the air sample via the sample line.

2. The air sampling system of claim 1, wherein step (b) is performed before step (a).

3. The air sampling system of claim 1, wherein step (b) is performed after step (a).

4. The air sampling system of claim 1, wherein step (d) comprises identifying the one of the sample inlets from which the air sample originated in step (a).

5. The air sampling system of claim 1, wherein step (d) comprises controlling the valves to further transmit the air sample via the sample line.

6. The air sampling system of claim 1, wherein the burp patterns are defined by one or a combination of a number of burps, a duration of burps, a duration of intervals between burps, or a plurality of signal gas compositions.

7. The air sampling system of claim 1, wherein the signal gas comprises methane or ethane.

8. An air sampling method using a sample line for transmitting gas streams and a plurality of air sample inlets connected to the sample line, the air sampling method comprising the steps of:
(a) transmitting, via the sample line, an air sample originating from one of the sample inlets;
(b) before or after step (a), transmitting, via the sample line, a signal gas in accordance with one of a plurality of predefined burp patterns, wherein each predefined burp pattern uniquely corresponds to a different one of the sample inlets, and the one of the predefined burp patterns uniquely corresponds to the one of sample inlets from which the air sample originated in step (a);
(c) monitoring the sample line for the signal gas in accordance with the predefined burp patterns; and
(d) based on detection of the signal gas in the sample line in accordance with the one of the predefined burp patterns used in step (b), taking a related action comprising:
(i) identifying the one of the sample inlets from which the air sample originated in step (a); or
(ii) further transmitting the air sample via the sample line.

9. The air sampling method of claim 8, wherein step (b) is performed before step (a).

10. The air sampling method of claim 8, wherein step (b) is performed after step (a).

11. The air sampling method of claim 8, wherein step (d) comprises identifying the one of the sample inlets from which the air sample originated in step (a).

12. The air sampling method of claim 8, wherein step (d) comprises further transmitting the air sample via the sample line.

13. The air sampling method of claim 8, wherein the burp patterns are defined by one or a combination of a number of burps, a duration of burps, a duration of intervals between burps, or a plurality of signal gas compositions.

14. The air sampling method of claim 8, wherein the signal gas comprises methane or ethane.
